(19) United States
(12) Patent Application Publication
(10) Pub. No.: US 2025/0083312 A1
(43) Pub. Date: Mar. 13, 2025

(54) SUBSTRATE GRIPPING ASSEMBLY WITH FEEDBACK CONTROL

(71) Applicant: Applied Materials, Inc., Santa Clara, CA (US)

(72) Inventors: Saitanay Naribole, Telangana (IN); Venkata Raghavaiah Chowdhary Kode, Pflugerville, TX (US); Jagadeesh Kilaru, Karnataka (IN); Chandrakant M. Sapkale, Bangalore (IN); Michael Carl Hankes, Austin, TX (US)

(21) Appl. No.: 18/243,266

(22) Filed: Sep. 7, 2023

(51) Int. Cl. B25J 9/16; B25J 13/08; B25J 19/00

(52) U.S. Cl. CPC B25J 9/1633; B25J 9/1679; B25J 13/085; B25J 19/0091

(57) ABSTRACT

A substrate gripping system includes a plunger body actuatable by an actuator and a gripper at a distal end of the plunger body. The gripper is configured to grip a substrate responsive to actuation of the plunger body by the actuator. The system further includes a sensor configured to measure a value of a parameter associated with actuation of the plunger body and a controller configured to cause the actuator to actuate the plunger body based at least partially on the value of the parameter measured by the sensor.

### TECHNICAL FIELD

Embodiments of the present disclosure generally relate to a substrate gripping assembly with feedback control and control methods of the same.

### BACKGROUND

Substrate transfer devices used in substrate processing use end effectors to transport substrates. Such transfer devices include end effectors that grip a substrate.

### SUMMARY

The following is a simplified summary of the disclosure in order to provide a basic understanding of some aspects of the disclosure. This summary is not an extensive overview of the disclosure. It is intended to neither identify key or critical elements of the disclosure, nor delineate any scope of the particular implementations of the disclosure or any scope of the claims. Its sole purpose is to present some concepts of the disclosure in a simplified form as a prelude to the more detailed description that is presented later.

Some of the embodiments described herein cover a substrate gripping system. The system includes a plunger body actuatable by an actuator and a gripper at a distal end of the plunger body. The gripper is configured to grip a substrate responsive to actuation of the plunger body by the actuator. The system further includes a sensor configured to measure a value of a parameter associated with actuation of the plunger body. The system further includes a controller configured to cause the actuator to actuate the plunger body based at least partially on the value of the parameter measured by the sensor.

Additional or related embodiments described herein cover a system includes a substrate gripping assembly and a controller to control the substrate gripping assembly. The substrate gripping assembly includes a plunger body, an actuator configured to actuate the plunger body, and a gripper coupled to the plunger body and configured to grip a substrate. The controller is configured to cause the actuator to actuate the plunger body. The gripper is caused to contact the substrate responsive to actuation of the plunger body. The controller is further configured to receive sensor data indicative of a value of a parameter associated with actuation of the plunger body. The controller is further configured to update a control signal to the actuator to update actuation of the plunger body based at least in part on the sensor data.

Further embodiments cover a method. The method includes causing an actuator to actuate a plunger body of a substrate gripping assembly. The method further includes receiving sensor data indicative of a value of a parameter associated with actuation of the plunger body responsive to a gripper coupled to the plunger body contacting a substrate. The method further includes updating a control signal to the actuator to update actuation of the plunger body based at least in part on the sensor data.

### BRIEF DESCRIPTION OF THE DRAWINGS

The present disclosure is illustrated by way of example, and not by way of limitation, in the figures of the accompanying drawings in which like references indicate similar elements. It should be noted that different references to “an” or “one” embodiment in this disclosure are not necessarily to the same embodiment, and such references mean at least one.

FIG. 1 is a top schematic view of an example manufacturing system, according to some embodiments.

FIG. 2A illustrates a perspective view of a robot apparatus, according to some embodiments.

FIG. 2B illustrates a top view of a robot apparatus, according to some embodiments.

FIG. 3A illustrates a schematic top view of a substrate gripping assembly, according to some embodiments.

FIGS. 3B-3D illustrate schematic side views of a substrate gripping assembly, according to some embodiments.

FIG. 4A illustrates a schematic top view of a substrate gripping assembly, according to some embodiments.

FIGS. 4B-4D illustrate schematic side views of a substrate gripping assembly, according to some embodiments.

FIG. 5A illustrates a schematic top view of a substrate gripping assembly, according to some embodiments.

FIG. 5B illustrates a schematic view of a portion of a substrate gripping assembly, according to some embodiments.

FIGS. 6A-6B illustrate control system algorithms for controlling a substrate gripping assembly, according to some embodiments.

FIG. 7 is a flow chart of a method of controlling a substrate gripping assembly, according to some embodiments.

FIG. 8 is a block diagram illustrating a computer system for use in accordance with the embodiments of the present disclosure.

### DETAILED DESCRIPTION OF EMBODIMENTS

Embodiments of the present disclosure are directed to a substrate gripping assembly with feedback control. Substrate handling devices include grippers to grip a substrate for handling. Often, a gripper is actuated to a gripping position to grip the substrate. An actuator causes the gripper to contact the substrate. The actuator may cause the gripper to apply a force on the substrate so that the substrate is sufficiently gripped by the assembly for handling. Conventionally, grippers are actuated without any feedback control. For example, an actuator commonly actuates using a preset control signal to cause the gripper to contact the substrate with a preset amount of force. Conventional substrate gripping assemblies do not use any kind of damping or feedback control. Conventional substrate gripping assemblies often use pneumatic cylinder actuators which have little control or damping. By gripping a substrate without damping or feedback control, grippers can enact an impulse on the substrate and/or grip the substrate with too much force, causing damage to the substrate and/or generating particles which can contaminate the substrate. Often, the speed at which conventional grippers are actuated is not controlled, leading to high impulse forces and velocities enacted upon substrates when the grippers are actuated. Excessively high impulse forces and/or velocities by grippers enacted upon substrates can cause damage to the substrates, particularly near the substrate edge. Damage caused by conventional substrate gripping assemblies can affect a substantial amount of processed substrates. The damage caused by conventional gripping assemblies can especially affect substrate edge film integrity. Excess damage to a substrate can lead to scrapping the damaged substrate.

Aspects and implementations of the instant disclosure address one or more of the above-described and/or other shortcomings of conventional systems by providing a substrate gripping assembly with active feedback control. In some embodiments, the substrate gripping assembly described herein includes a flexure-based plunger mechanism with strain gauge feedback for closed-loop control. The substrate gripping assembly may include active position and speed control for plunger movement. The substrate gripping assembly described herein may be a modular replacement for conventional substrate gripping assemblies.

In some embodiments, a substrate gripping system as disclosed herein includes a plunger body actuatable by an actuator and a gripper at a distal end of the plunger body. The gripper may be configured to grip a substrate responsive to actuation of the plunger body by the actuator. In some embodiments, the actuator is a servo-based actuator, a stepper-based actuator, a piezo-based (e.g., a piezo-electric-based) actuator, a rack-and-pinion-based actuator, or a stacked-solenoid actuator. In some embodiments, the actuator can be controlled to reduce the amount of force that the actuator applies to the plunger body. For example, a controller can send an initial control signal to the actuator to cause the actuator to actuate the plunger body with a first amount of force. Subsequently, the controller can update the control signal to cause the actuator to actuate the plunger body with a reduced second amount of force. Similarly, the actuator can be controlled to increase the amount of force that the actuator applies to the plunger body. The actuator can be controlled to reduce the speed at which the gripper contacts the substrate.

In some embodiments, the gripper coupled to the distal end of the plunger body is configured to apply force to a substrate when the plunger body is actuated. The gripper may contact the edge of the substrate when the plunger body is actuated. In some embodiments, the gripper is moved linearly along a path of travel when the plunger is actuated. The gripper may be guided linearly by a linear motion guide (e.g., a rail, a slot, etc.). In some embodiments, a linear motion guide (e.g., such as a rail) guides the plunger body and/or guides a coupling body that couples the actuator to the plunger body. The plunger body may be capable of linearly moving relative to the coupling body and may be guided by another linear motion guide.

In some embodiments, the gripper is rotatably coupled to the plunger body by a bearing and/or a pin. The gripper may be able to rotate with respect to the plunger body within a threshold range of rotation. Allowing the gripper to rotate with respect to the plunger body may reduce the amount of particles generated when the gripper is in contact with a substrate. In some embodiments, a damper reduces an impulse of the gripper on the substrate when the plunger body is actuated. The damper may include a mechanical damper, a pre-loaded spring damper, damping pad(s), a cushion, a compliant joint (e.g., such as a flexure joint as described herein below), and/or an electromagnetic damper. The damper may slow the velocity of the gripper as the gripper moves to contact the substrate so that the impact velocity and/or force of the gripper on the substrate is reduced.

In some embodiments, a sensor measures a value of a parameter that is associated with actuation of the plunger body. In some embodiments, the sensor measures applied force, plunger body velocity, plunger body displacement, and/or strain in a flexure joint (e.g., of the plunger body as described herein below). In some embodiments, the value of the parameter measured by the sensor is indicative of force applied by the gripper on a gripped substrate. In some embodiments, the sensor is coupled to the plunger body, a damper, and/or to a coupling body that couples the actuator to the plunger body. The sensor may be a strain gauge or a force sensor (e.g., such as a piezoelectric force sensor).

In some embodiments, a controller causes the actuator to actuate the plunger body. The controller may send a control signal to the actuator to cause the actuator to actuate the plunger body which may cause the gripper to move to a gripping position (e.g., to grip a substrate). The gripper may contact the substrate when the plunger body is sufficiently actuated. In some embodiments, the controller receives data from the sensor. The sensor data may be indicative of force applied by the gripper on the substrate (e.g., force applied by the gripper on the edge of the substrate). In some embodiments, the controller determines the amount of force applied by the gripper on the substrate using the sensor data. In some embodiments, the controller updates the control signal to the actuator to update actuation of the plunger body. The update to the control signal may be based at least in part on the sensor data. In some embodiments, the controller updates the control signal so that less than a threshold amount of force is applied by the gripper on the substrate. The threshold amount of force may correspond to an amount of force above which damage to the substrate can occur.

Embodiments of the present disclosure provide advantages over conventional systems described above. Particularly, some embodiments described herein provide feedback control for substrate gripping assemblies and/or systems. By providing feedback control, a substrate gripper may be caused to apply a safe amount of force to a substrate that will not damage the substrate. Additionally, some embodiments described herein provide for damping of the impulse that a gripper enacts upon a substrate when actuated to a gripping position to grip a substrate. Damping the gripper impulse may reduce the gripping force and/or velocity which may reduce damage to the substrate and may reduce the amount of particles generated. In some embodiments, by reducing damage to substrates, especially substrate edges, fewer substrates may be scrapped, leading to an overall greater throughput of a substrate processing system. Moreover, the substrate gripper described herein may operate so that product yields are increased when compared to conventional systems.

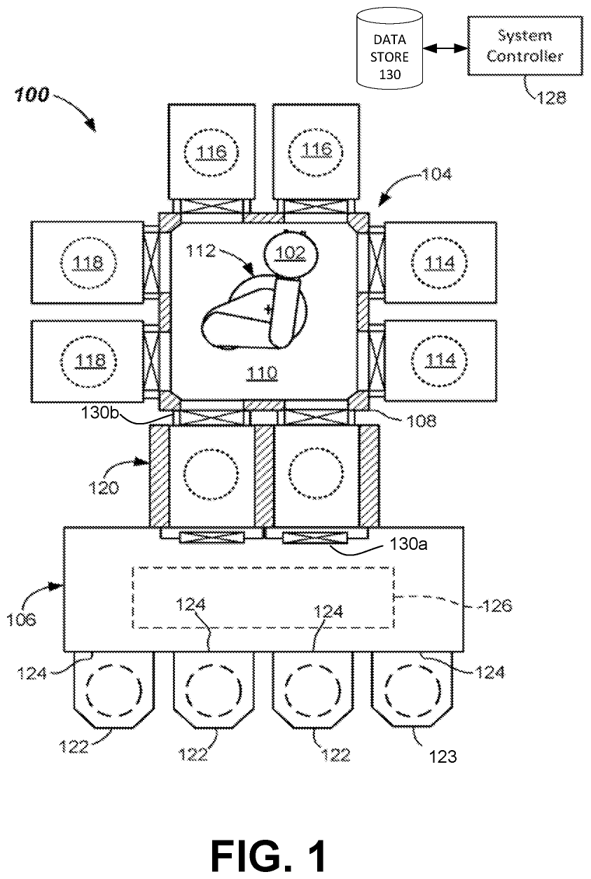

FIG. 1 is a top schematic view of an example manufacturing system 100, according to some embodiments. Manufacturing system 100 can perform one or more processes on a substrate 102. Substrate 102 can be any suitably rigid, fixed-dimension, planar article, such as, e.g., a silicon-containing disc or wafer, a patterned wafer, a glass plate, or the like, suitable for fabricating electronic devices or circuit components thereon.

Manufacturing system 100 can include a process tool 104 and a factory interface 106 coupled to process tool 104. Process tool 104 can include a housing 108 having a transfer chamber 110 therein. Transfer chamber 110 can include one or more process chambers (also referred to as processing chambers) 114, 116, 118 disposed therearound and coupled thereto. Process chambers 114, 116, 118 can be coupled to transfer chamber 110 through respective ports, such as slit valves or the like.

Process chambers 114, 116, 118 can be adapted to carry out any number of processes on substrates 102. A same or different substrate process can take place in each process chamber 114, 116, 118. A substrate process can include atomic layer deposition (ALD), physical vapor deposition (PVD), chemical vapor deposition (CVD), etching, annealing, curing, pre-cleaning, metal or metal oxide removal, or the like. In one example, a PVD process can be performed in one or both of process chambers 114, an etching process can be performed in one or both of process chambers 116, and an annealing process can be performed in one or both of process chambers 118. Other processes can be carried out on substrates 102 therein. Process chambers 114, 116, 118 can each include a substrate support assembly. The substrate support assembly can be configured to hold substrate 102 in place while a substrate process is performed.

In some embodiments, a process chamber 114, 116, 118 can include a carousel (also referred to as a susceptor). The carousel can be disposed in an interior volume of the process chamber 114, 116, 118 and can be configured to rotate about an axial center at the process chamber 114, 116, 118 during a process (e.g., a deposition process) to ensure process gases are evenly distributed. In some embodiments, the carousel can include one or more end effectors configured to handle one or more objects. For example, the end effectors can be configured to hold a substrate, a process kit, and/or a process kit carrier. One or more sensors can be disposed at the process chamber 114, 116, 118 and can be configured to detect a placement of an object on an end effector of the carousel, in accordance with embodiments described herein.

Transfer chamber 110 can also include a transfer chamber robot 112. Transfer chamber robot 112 can include one or multiple arms where each arm includes one or more end effectors at the end of each arm. The end effector can be configured to handle particular objects, such as substrates. Alternatively, or additionally, the end effector can be configured to handle process kits (i.e., using a process kit carrier). In some embodiments, transfer chamber robot 112 can be a selective compliance assembly robot arm (SCARA) robot, such as a 2 link SCARA robot, a 3 link SCARA robot, a 4 link SCARA robot, and so on. In some embodiments, transfer chamber robot 112 includes a substrate gripper assembly having feedback control as described herein. The feedback control may reduce an impulse and/or force imparted on a handled substrate by the gripping assembly to reduce the likelihood of substrate damage and/or to reduce the amount of generated particles. The substrate gripper assembly may include a damper as described herein to reduce gripper velocity and/or force applied to a substrate.

A load lock 120 can also be coupled to housing 108 and substrate transfer chamber 110. Load lock 120 can be configured to interface with, and be coupled to, transfer chamber 110 on one side and factory interface 106. Load lock 120 can have an environmentally-controlled atmosphere that can be changed from a vacuum environment (wherein substrates can be transferred to and from transfer chamber 110) to an at or near atmospheric-pressure inert-gas environment (wherein substrates can be transferred to and from factory interface 106) in some embodiments. In some embodiments, load lock 120 can be a stacked load lock having a pair of upper interior chambers and a pair of lower interior chambers that are located at different vertical levels (e.g., one above another). In some embodiments, the pair of upper interior chambers can be configured to receive processed substrates from transfer chamber 110 for removal from process tool 104, while the pair of lower interior chambers can be configured to receive substrates from factory interface 106 for processing in process tool 104. In some embodiments, load lock 120 can be configured to perform a substrate process (e.g., an etch or a pre-clean) on one or more substrates 102 received therein.

Factory interface 106 can be any suitable enclosure, such as, e.g., an Equipment Front End Module (EFEM). Factory interface 106 can be configured to receive substrates 102 from substrate carriers 122 (e.g., Front Opening Unified Pods (FOUPs)) docked at various load ports 124 of factory interface 106. A factory interface robot 126 (shown dotted) can be configured to transfer substrates 102 between substrate carriers 122 (also referred to as containers) and load lock 120. In other and/or similar embodiments, factory interface 106 can be configured to receive replacement parts (e.g., process kits) from replacement parts storage containers 123. Factory interface robot 126 can include one or more robot arms and can be or include a SCARA robot. In some embodiments, factory interface robot 126 can have more links and/or more degrees of freedom than transfer chamber robot 112. Factory interface robot 126 can include an end effector on an end of each robot arm. The end effector can be configured to pick up and handle specific objects, such as substrates or process kits. Alternatively, or additionally, the end effector can be configured to handle objects such as process kits (e.g., using process kit carriers). In some embodiments, the end effector of the factory interface robot 126 has a substrate gripping assembly with feedback control and/or a damper as described herein to reduce damage to handled substrates.

Any conventional robot type can be used for factory interface robot 126. Transfers can be carried out in any order or direction. Factory interface 106 can be maintained in, e.g., a slightly positive-pressure non-reactive gas environment (using, e.g., nitrogen as the non-reactive gas) in some embodiments.

In some embodiments, transfer chamber 110, process chambers 114, 116, and 118, and load lock 120 can be maintained at a vacuum level. Manufacturing system 100 can include one or more vacuum ports that are coupled to one or more stations of manufacturing system 100. For example, first vacuum ports 130a can couple factory interface 106 to load locks 120. Second vacuum ports 130b can be coupled to load locks 120 and disposed between load locks 120 and transfer chamber 110.

In some embodiments, one or more sensors can be included at one or more stations of manufacturing system 100. For example, one or more sensors can be included in transfer chamber 110 at or near a port (i.e., an entrance) of process chambers 114, 116, 118. An end effector of a robot arm (e.g., of transfer chamber robot 112) can move a substrate 102 or a process kit (i.e. using a process kit carrier) past the one or more sensors when moving the substrate 102 and/or process kit into or out of a process chamber 114, 116, 118. Each sensor can be configured to detect the substrate 102 or the process kit and/or carrier as the end effector moves the substrate 102 or the process kit and/or carrier into or out of the process chamber 114, 116, 118.

Manufacturing system 100 can also include a system controller 128. System controller 128 can be and/or include a computing device such as a personal computer, a server computer, a programmable logic controller (PLC), a microcontroller, and so on. System controller 128 can include one or more processing devices, which can be general-purpose processing devices such as a microprocessor, central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processing device can also be one or more special-purpose processing devices such as an application specific integrated circuit (ASIC), a field programmable gate array (FPGA), a digital signal processor (DSP), network processor, or the like. System controller 128 can include a data storage device (e.g., one or more disk drives and/or solid state drives), a main memory, a static memory, a network interface, and/or other components. System controller 128 can execute instructions to perform any one or more of the methodologies and/or embodiments described herein. The instructions can be stored on a computer readable storage medium, which can include the main memory, static memory, secondary storage and/or processing device (during execution of the instructions).

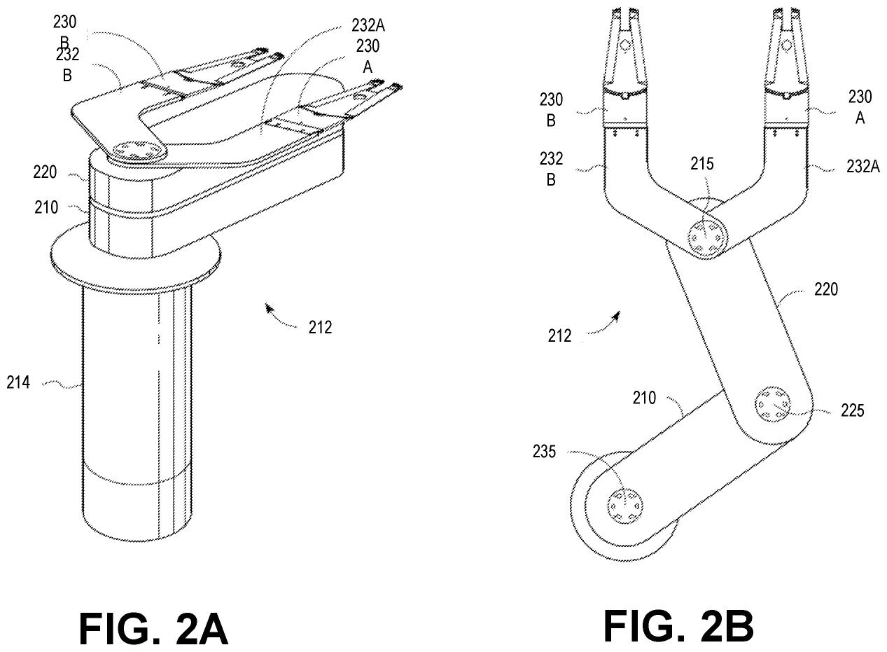

FIG. 2A illustrates a perspective view of a robot apparatus 212 according to some embodiments. FIG. 2B illustrates a top view of robot apparatus 212 according to some embodiments. In some embodiments, robot apparatus 212 is illustrated having dual end effectors. However, in some embodiments, a robot apparatus can have a single end effector or any number of end effectors. The robot apparatus 212 may include one lower arm 210 configured to rotate about the first rotational axis 215. For example, one or more motors (not shown) located in the base 214 may rotate the one lower arm 210 about the first rotational axis 215. The robot apparatus 212 may further include one upper arm 220 rotatably coupled to the one lower arm 210 at a second rotational axis 225 that is spaced away from the first rotational axis 215. Upper arm 220 may be configured to rotate about the second rotational axis 225. For example, one or more motors (not shown) located in the base 214 may rotate the one upper arm 220 about the second rotational axis 225. In some embodiments, portions of the lower arm 210 and portions of the upper arm 220 may operate on different planes, one above the other.

The robot apparatus 212 may further include a first end effector 230A that is rotatably coupled to the one upper arm 220 at a third rotational axis 235 spaced from the second rotational axis 225. The first end effector may include a first bend 232A in a first direction within a horizontal plane. The robot apparatus 102A may also include a second end effector 230B that is rotatably coupled to the one upper arm 220 at the third rotational axis 235. The second end effector may include a second bend 232B in a second direction within a horizontal plane, wherein the second direction is opposite the first direction. The first end effector 230A and the second end effector 230B may be configured to rotate independently about the third rotational axis 235 for both, the dual substrate handling mode and the single substrate handling mode. For example, one or more motors (not shown) located in the base 214 may independently rotate the first end effector 230A and second end effector 230B about the third rotational axis 235 or both, the dual substrate handling mode and the single substrate handling mode. In some embodiments, the first end effector 230A and/or the second end effector 230B are sufficiently thin to fit between a wafer slot (e.g., of a substrate carrier) to retrieve or place a substrate (e.g., in a substrate carrier).

In some embodiments, the first end effector 230A and/or the second end effector 230B include substrate gripping systems with feedback control. For example, first end effector 230A may include a substrate gripping system having a plunger body and a gripper at a distal end of the plunger body. The plunger body may be actuated by an actuator so that the gripper is moved into a gripping position to grip a substrate. A sensor may measure data indicative of force applied by the gripper on the gripped substrate. A controller may cause the actuator to update actuation (e.g., change actuation, etc.) based on the sensor data so that less than a threshold amount of force is applied by the gripper on the substrate.

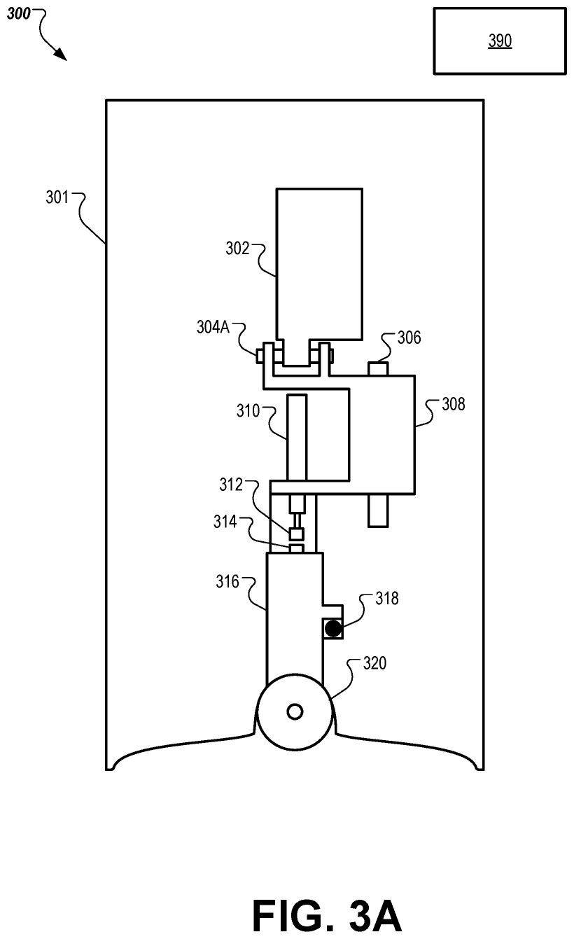

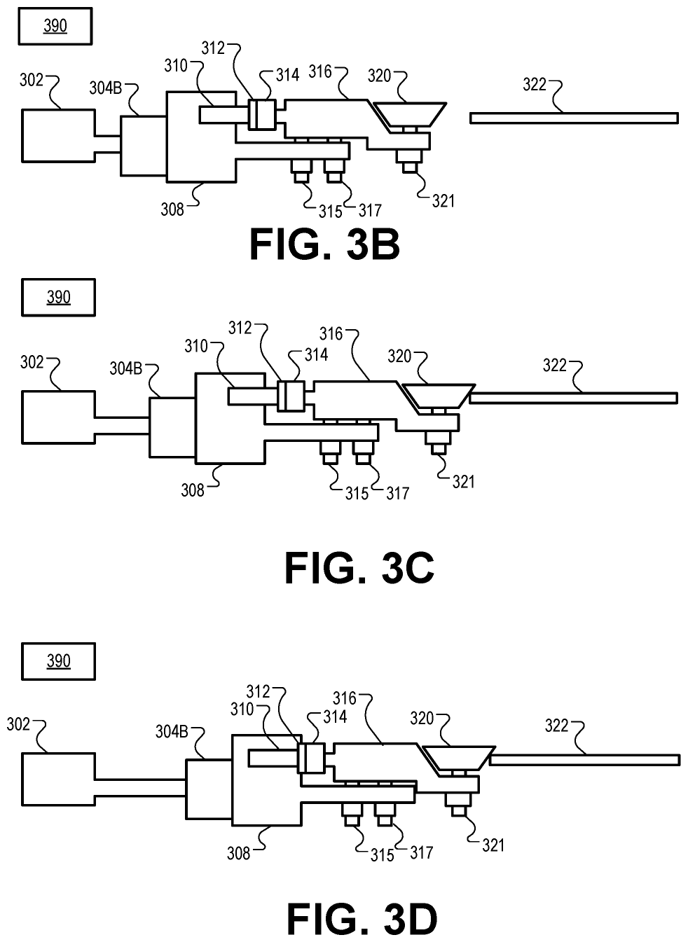

FIG. 3A illustrates a schematic top view of a substrate gripping assembly 300, according to some embodiments. In some embodiments, substrate gripping assembly 300 includes a base 301 to which multiple components are attached. In some embodiments, actuator 302 is coupled to the base. Actuator 302 may actuate based on one or more control signals from controller 390. Controller 390 may be coupled to base 301 or may be located remote. In some embodiments, the control signal (e.g., from controller 390) can cause actuator 302 to actuate to a position related to the control signal and/or to actuate to provide an output force related to the control signal. Actuator 302 is selected from a group consisting of a servo actuator, a stepper actuator, a stacked-solenoid actuator (e.g., a first solenoid and a second solenoid coupled together in a ‘stacked’ configuration), a rack-and-pinion-based actuator, or a piezoelectric-based actuator. In some embodiments, the extension of actuator 302 is controllable by controller 390. Controller 390 may send a control signal to actuator 302 to control a servomotor or a stepper motor of actuator 302 to cause extension or retraction of actuator 302. In some embodiments, controller 390 sends an electrical signal to a piezoelectric actuator to control extension of actuator 302. In some embodiments, controller 390 controls a motor of actuator 302 that turns a gear (e.g., a pinion) to extend or retract a linear gear (e.g., a rack). In some embodiments, controller 390 controls extension of a first solenoid to control extension of actuator 302 and further controls a second solenoid coupled to the first solenoid (e.g., in a stacked configuration) to control the amount of force output by the actuator 302.

In some embodiments, an output member of actuator 302 is coupled to a coupling body 308 by a pin 304A. In some embodiments, coupling body 308 is coupled to plunger body 316. Actuation of the actuator 302 may cause actuation of the plunger body 316 via the coupling body 308. In some embodiments, the coupling body 308 moves exactly with the output member of actuator 302 while the plunger body 316 may move relative to the coupling body 308. In some embodiments, movement of coupling body 308 influences movement of plunger body 316. For example, plunger body 316 may be coupled to coupling body 308 by a sliding joint so that the plunger body 316 may move linearly relative to the coupling body 308 (e.g., when gripper 320 contacts a substrate). The sliding joint may form a linear motion guide. In some embodiments, coupling body 308 includes a stopper 318 to control range of motion of the plunger body 316 relative to the coupling body 308. The stopper 318 may allow the coupling body 308 to extend relative to the plunger body 316 but may not allow the plunger body 316 to extend relative to the coupling body 308 past a threshold position. A linear motion guide (e.g., a rail, a slot, etc.) on coupling body 308 may control the motion of plunger body 316 relative to coupling body 308 so that plunger body 316 move linearly. A linear motion guide 306 coupled to base 301 may control motion of coupling body 308. The linear motion guide 306 may be a rail that is received by a corresponding slot in the bottom surface of the coupling body.

In some embodiments, gripper 320 is coupled at a distal end of plunger body 316 opposite the coupling body 308. Gripper 320 may be configured to contact a substrate. In some embodiments, gripper 320 includes a round body and may include a chamfered circumferential edge. The circumferential edge of gripper 320 may contact a substrate responsive to actuation of the plunger body 316. In some embodiments, gripper 320 is a roller and can rotate about a central axis with respect to the plunger body 316.

In some embodiments, a force sensor 314 is coupled to plunger body 316. In some embodiments, force sensor 314 is coupled to gripper 320. Force sensor 314 may be a piezoelectric sensor that measures pressure applied by a contacting body. In some embodiments, a contact surface 312 coupled on the end of damper 310 contacts a surface of force sensor 314. In some embodiments, damper 310 is coupled to coupling body 308. In some embodiments, force is applied to plunger body 316 through the damper 310, contact surface 312, and/or force sensor 314. Damper 310 may act as a cushion or a spring, etc. to transfer applied force from coupling body 308 to plunger body 316. As described below with respect to FIGS. 3B-3D, as actuator 302 pushes on coupling body 308 (e.g., as actuator 302 actuates coupling body 308), contact surface 312 (e.g., coupled to damper 310 which is coupled to coupling body 308) pushes on force sensor 314. The pushing on force sensor 314 by contact surface 312 may cause plunger body 316 to move until gripper 320 contacts a substrate. The force detected by force sensor 314 may then increase as actuator 302 continues to push on coupling body 308 while plunger body 316 resists movement due to gripper 320 contacting the substrate. In some embodiments, controller 390 receives data from sensor 314 and determines the force applied by the gripper 320 on the substrate using the sensor data. In some embodiments, the sensor data is filtered using a filtering algorithm such as a running average filter, etc. The filtering algorithm may take place in software, firmware, and/or in a signal processor (e.g., digital signal processor, etc.). The controller 390 can update a control signal output to the actuator 302 based on the determined force so that less than a threshold amount of force is applied by the gripper 320 on the substrate. In some embodiments, the threshold amount of force is between approximately 2 Newtons and 4 Newtons, between approximately 4 Newtons and 6 Newtons, between approximately 6 Newtons and 8 Newtons, or between approximately 8 Newtons and 10 Newtons. In some embodiments, the threshold amount of force is tunable (e.g., by a user, an engineer, a technician, etc.). In some embodiments, the threshold amount of force is tunable within a range greater or less than two Newtons.

Controller 390 can be and/or include a computing device such as a personal computer, a server computer, a programmable logic controller (PLC), a microcontroller, and so on. Controller 390 can include one or more processing devices, which can be general-purpose processing devices such as a microprocessor, central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processing device can also be one or more special-purpose processing devices such as an application specific integrated circuit (ASIC), a field programmable gate array (FPGA), a digital signal processor (DSP), network processor, or the like. Controller 390 can include a data storage device (e.g., one or more disk drives and/or solid state drives), a main memory, a static memory, a network interface, and/or other components. Controller 390 can execute instructions to perform any one or more of the methodologies and/or embodiments described herein. The instructions can be stored on a computer readable storage medium, which can include the main memory, static memory, secondary storage and/or processing device (during execution of the instructions).

FIGS. 3B-3D illustrate schematic side views of a substrate gripping assembly, according to some embodiments. Elements illustrated in FIGS. 3B-3D having same or similar reference numbers to those in other figures may have similar or same structure and/or functionality. Referring to FIG. 3B, an initial position of a substrate gripping assembly is shown. In some embodiments, actuator 302 is in an un-actuated or retracted state. In some embodiments, actuator 302 may be coupled to coupling body 308 by a flex coupling 304B. In some embodiments, gripper 320 is coupled to the plunger body 316 by a pin 321 and/or a threaded stud and a nut. In some embodiments, the distance between gripper 320 and the edge of substrate 322 is between approximately 5 mm and 10 mm. In some embodiments, the distance between gripper 320 and the edge of substrate 322 is approximately 8 mm. In the initial position shown in FIG. 3B, there is contact between the contact surface 312 and the force sensor 314. The damper 310 may be in an uncompressed state. In some embodiments, there is an amount of preload on the damper 310. In some embodiments, when in the initial position shown in FIG. 3B, the plunger body 316 is in the most extended position (e.g., the rightmost position as illustrated) of a sliding joint between the plunger body 316 and the coupling body 308. In some embodiments, the sliding joint is formed by pins 315 and 317. In some embodiments, pins 315 and 317 ride in a linear slot formed in the coupling body 308 and couple plunger body 316 to coupling body 308 while allowing a degree of freedom between the plunger body 316 and the coupling body 308. The linear slot may form a linear motion guide. In some embodiments, plunger body 316 is linearly guided by the slot formed in the coupling body 308 and pins 315 and 317.

Referring to FIG. 3C, an initial substrate contact position of a substrate gripping assembly is shown. In some embodiments, in the position shown in FIG. 3C, there is initial contact with substrate 322 (e.g., by gripper 320). In some embodiments, actuator 302 is extended to a first extended position. The first extended position may be between approximately 5 mm and 10 mm extension. In some embodiments, the first extended position is approximately 8 mm extension. The distance between gripper 320 and the edge of substrate 322 is zero (e.g., gripper 320 is contacting substrate 322). In some embodiments, as gripper 320 contacts substrate 322, the damper 310 begins to compress and plunger body 316 begins to move linearly with respect to the coupling body 308. The plunger body 316 may move from the most extended position of the sliding joint (e.g., to the left as illustrated). In some embodiments, compression of damper 310 decreases the impulse gripper 320 imparts on the edge of substrate 322 by reducing the impulse force and/or by reducing the impulse velocity. In some embodiments, the force detected by force sensor 314 begins to increase. Controller 390 may receive the sensor data, determine the amount of force exerted by gripper 320 on substrate 322, and adjust a control signal to actuator 302 accordingly so that gripper 320 exerts less than a threshold amount of force on the edge of substrate 322.

Referring to FIG. 3D, a substrate clamping position of a substrate gripping assembly is shown. In some embodiments, in the position shown in FIG. 3D, there is a gripping force exerted on substrate 322 (e.g., by gripper 320). In some embodiments, actuator 302 is extended to a second extended position. The second extended position may be, for example, between approximately 8 mm and 12 mm extension. In some embodiments, the second extended position is, for example, approximately 10 mm extension. The second extended position may be any position, dependent on substrate location and/or substrate size (e.g., diameter, etc.). In some embodiments, damper 310 is compressed and plunger body 316 is in a compressed position (e.g., the leftmost position as illustrated). The force detected by force sensor 314 is increased. Controller 390 may use the sensor data from force sensor 314 to detect when the threshold amount of force is exerted by gripper 320 on substrate 322. Controller 390 may stop actuation (e.g., of plunger body 316 by actuator 302) when the threshold amount of force is met.

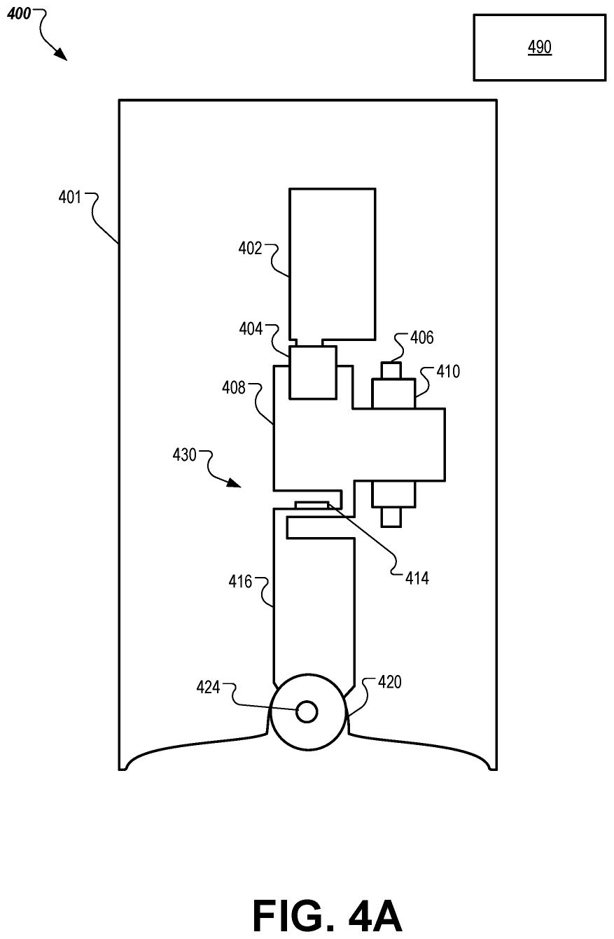

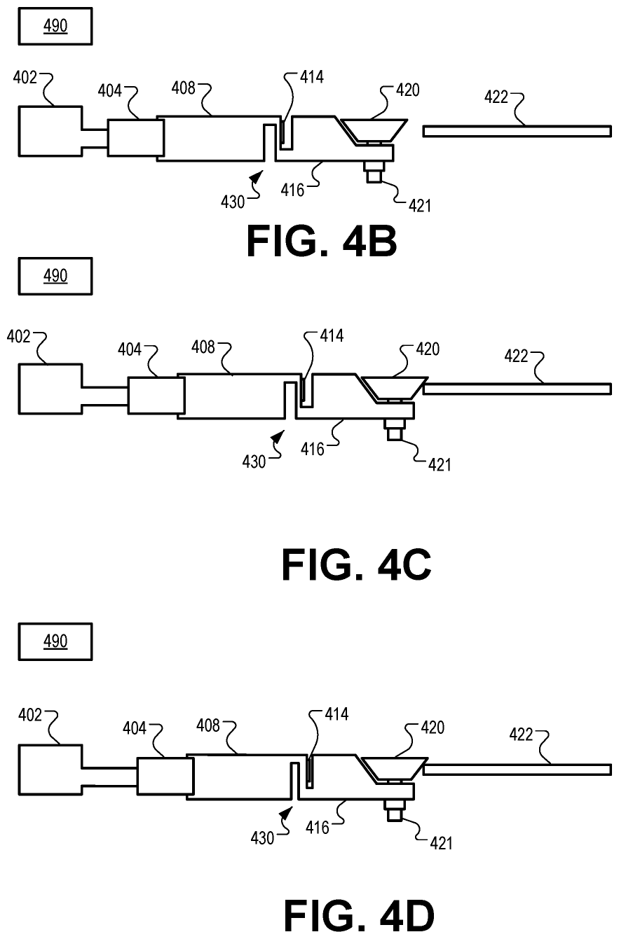

FIG. 4A illustrates a schematic top view of a substrate gripping assembly 400, according to some embodiments. Elements illustrated in FIG. 4A having same or similar reference numbers to those in other figures may have similar or same structure and/or functionality. In some embodiments, actuator 402 disposed on base 401 is coupled to coupling body 408 by a flex coupling 404. Flex coupling 404 may be coupled to coupling body 408 by a pin (not illustrated). In some embodiments, linear motion guide 406 allows the coupling body 408 to move linearly when actuator 402 extends and retracts. In some embodiments, damper 410 dampens the motion of coupling body 408.

In some embodiments, plunger body 416 is coupled to coupling body 408 by a flexure joint 430. In some embodiments, flexure joint 430 allows for at least a threshold amount of flex and/or compression between plunger body 416 and coupling body 408. In some embodiments, flexure joint 430 includes a thin flexible material between coupling body 408 and plunger body 416. In some embodiments, the material of flexure joint 430 is formed in a zig-zag pattern to couple coupling body 408 with plunger body 416. In some embodiments, flexure joint 430 may compress when actuator 402 is extended and gripper 420 contacts a substrate. Similarly, flexure joint 430 may decompress when actuator 402 retracts. In some embodiments, a strain gauge 414 is bonded to a portion of flexure joint 430. In some embodiments, strain gauge 414 is bonded to a center portion of flexure joint 430. In some embodiments, strain gauge 414 is coupled to gripper 420. Strain gauge 414 may measure the strain of flexure joint 430 as flexure joint 430 compresses and extends (e.g., responsive to actuation by actuator 402). Strain gauge 414 may be pre-strained when bonded to the flexure joint 430. In some embodiments, controller 490 receives strain data from strain gauge 414 and determines the amount of compressive or tensile force in the flexure joint 430. The amount of compressive force in the flexure joint 430 may correspond to the amount of force exerted by gripper 420 on a substrate. In some embodiments, controller 490 controls actuator 402 based on the strain data so that less than a threshold amount of force is applied by the gripper 420 on a gripped substrate.

In some embodiments, controller 490 can determine the presence of a substrate (e.g., the presence of a substrate gripped by gripper 420) based on a change in strain data from strain gauge 414. In some embodiments, controller 490 determines the presence of a substrate based on data from one or more photoelectric limit sensors or switches. One or more photoelectric limit switches may include projected beams of light. Motion of the plunger body 416 and/or the coupling body 408 may break one or more projected beams when the gripper 420 contacts a substrate, due to motion of the plunger body 416 relative to the coupling body 408. When the controller 490 detects that a beam has been broken, the controller 490 may determine the presence of a substrate in contact with gripper 420.

In some embodiments, gripper 420 is coupled at the distal end of plunger body 416 by a bearing 424. In some embodiments, bearing 424 allows gripper 420 to rotate with respect to the plunger body 416. Bearing 424 may allow gripper 420 a threshold range of rotation. Bearing 424 may allow gripper 420 to rotate to reduce slippage between gripper 420 and a substrate edge, which may reduce particles generated. In some embodiments, bearing 424 is a torsional flexure bearing with a limited range of motion. The range of motion of bearing 424 may be dependent upon the stiffness of the bearing, substrate plunging distance, and/or a substrate thickness profile, etc. In some embodiments, bearing 424 allows gripper 420 to rotate between approximately 10 degrees and 30 degrees. In some embodiments, bearing 424 allows gripper 420 to rotate approximately 20 degrees. In some embodiments, the range of motion of bearing 424 is variable. Bearing 424 may be disposed between an inner surface of gripper 420 and a pin.

FIGS. 4B-4D illustrate schematic side views of a substrate gripping assembly, according to some embodiments. Elements illustrated in FIGS. 4B-4D having same or similar reference numbers to those in other figures may have similar or same structure and/or functionality. Referring to FIG. 4B, an initial position of a substrate gripping assembly is shown. In some embodiments, actuator 402 is in an un-actuated or a retracted state. In some embodiments, gripper 420 is coupled to plunger body 416 by a pin 421. In some embodiments, the distance between gripper 420 and the edge of substrate 422 is between approximately 5 mm and 10 mm. In some embodiments, the distance between gripper 420 and the edge of substrate 422 is approximately 8 mm. In the initial position shown in FIG. 4B, the flexure joint 430 is in a relaxed state. Data from strain gauge 414 may indicate a state of zero strain in flexure joint 430.

Referring to FIG. 4C, an initial substrate contact position of a substrate gripping assembly is shown. In some embodiments, in the position shown in FIG. 4C, there is initial contact with substrate 422 (e.g., by gripper 420). In some embodiments, actuator 402 is extended to a first extended position. The first extended position may be between approximately 5 mm and 10 mm extension. In some embodiments, the first extended position is approximately 8 mm extension. The distance between gripper 420 and the edge of substrate 422 is zero (e.g., gripper 420 is contacting substrate 422). In some embodiments, as gripper 420 contacts substrate 422, flexure joint 430 begins to compress and plunger body 416 begins to move with respect to the coupling body 408. In some embodiments, compression of flexure joint 430 decreases the impulse gripper 420 imparts on the edge of substrate 422 by reducing the impulse force and/or by reducing the impulse velocity. In some embodiments, strain gauge 414 begins to detect increased strain in flexure joint 430 (e.g., as flexure joint 430 compresses). Controller 490 may receive the strain data, determine the amount of force exerted by gripper 420 on substrate 422, and adjust a control signal to actuator 402 accordingly so that gripper 420 exerts less than a threshold amount of force on the edge of substrate 422.

Referring to FIG. 4D, a substrate clamping position of a substrate gripping assembly is shown. In some embodiments, in the position shown in FIG. 4D, there is a gripping force exerted on substrate 422 (e.g., by gripper 420). In some embodiments, actuator 402 is extended to a second extended position. The second extended position may be between approximately 8 mm and 12 mm extension. In some embodiments, the second extended position is approximately 10 mm extension. In some embodiments, flexure joint 430 is compressed. The strain detected by strain gauge 414 is increased. Controller 490 may use the strain data (e.g., from strain gauge 414) to detect when the threshold amount of force is exerted by gripper 420 on substrate 422. Controller 490 may stop actuation (e.g., of plunger body 416 by actuator 402) when the threshold amount of force is met.

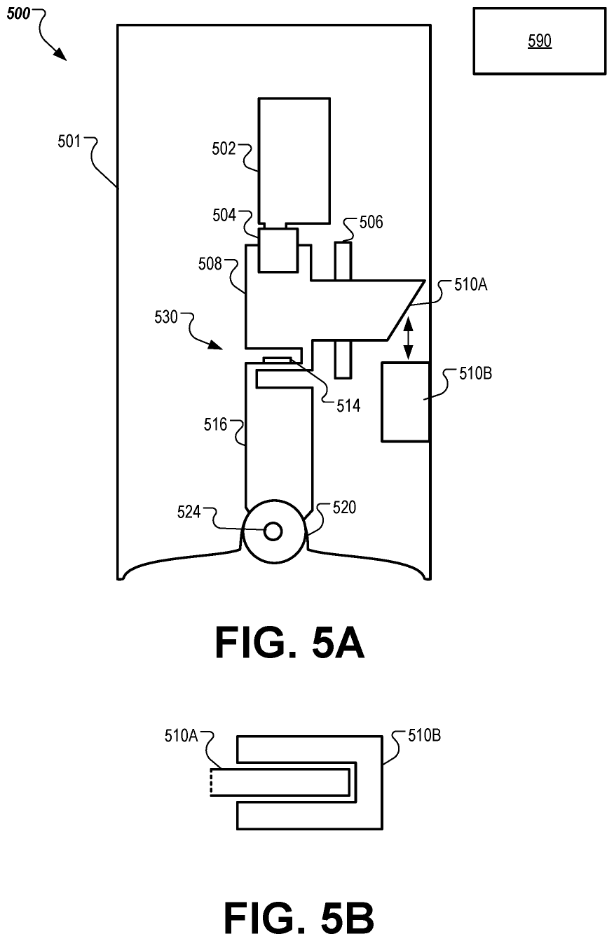

FIG. 5A illustrates a schematic top view of a substrate gripping assembly 500, according to some embodiments. Elements illustrated in FIG. 5A having same or similar reference numbers to those in other figures may have similar or same structure and/or functionality. In some embodiments, an actuator 502 disposed on a base 501 is coupled to a coupling body 508 by a flex coupling 504. In some embodiments, linear motion guide 506 allows the coupling body 508 to move linearly when actuator 502 extends and retracts.

In some embodiments, a plunger body 516 is coupled to coupling body 508 by a flexure joint 530. A strain gauge 514 may be bonded to a center portion of flexure joint 530. In some embodiments, a gripper 520 is coupled at a distal end of plunger body 516. A bearing 524 may allow at least a threshold amount of rotation of gripper 520 with respect to plunger body 516.

In some embodiments, motion of coupling body 508 is damped by electromagnetic force(s). In some embodiments, coupling body 508 includes an extension 510A that interacts with an electromagnet 510B. Referring to FIG. 5B, a schematic view of a portion of substrate gripping assembly 500 is shown, according to some embodiments. In some embodiments, extension 510A fits into a slot formed in electromagnet 510B as coupling body 508 moves back and forth responsive to extension and retraction of actuator 502. In some embodiments, extension 510A includes a copper plate. Controller 590 can increase or decrease electrical current provided to electromagnet 510B to increase or decrease electromagnetic forces exerted on extension 510A (e.g., by electromagnet 510B). The electromagnetic forces may reduce the speed of the coupling body 508 and/or may reduce the force exerted by the gripper 520 on a substrate. In some embodiments, controller 590 can activate electromagnet 510B upon the detection of contact between gripper 520 and a substrate. When gripper 520 contacts a substrate, flexure joint 530 may compress. Strain gauge 514 may detect a change in strain within flexure joint 530 and controller 590 may determine that gripper 520 has contacted a substrate based on the change in strain data. Upon detection of a contacted substrate, controller 590 may activate electromagnet 510B to induce electromagnetic force on the extension 510A to slow the progress of coupling body 508. In some embodiments, slowing progress of coupling body 508 reduces the impulse force and/or velocity of gripper 520 on a substrate. By including an electromagnetic damper formed by extension 510A and electromagnet 510B, a smaller degree of control can be exercised over actuator 502. For example, by controlling an electromagnetic damper to induce a damping force on coupling body 508, actuator 502 may be a pneumatic actuator with limited control.

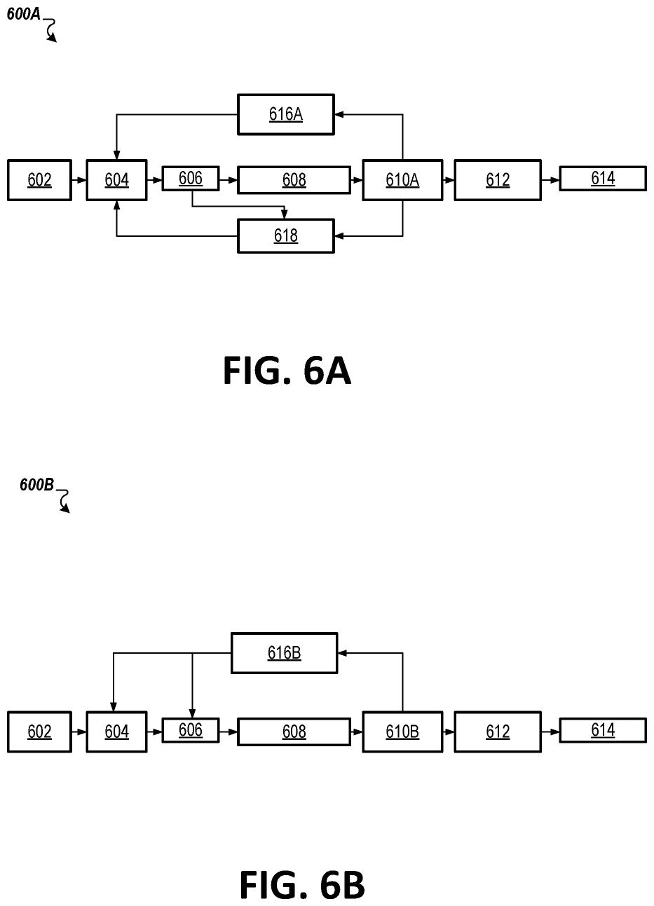

FIGS. 6A-6B illustrate control system algorithms for controlling a substrate gripping assembly, according to some embodiments. Referring to FIG. 6A, a control algorithm 600A for controlling a substrate gripping assembly such as substrate gripping assembly 300 of FIGS. 3A-3D is shown, according to some embodiments. In some embodiments, a power source 602 provides power (e.g., electrical energy, etc.) to a driver circuit 604. The driver circuit 604 outputs an electrical signal to an actuator 606 to cause extension or retraction of the actuator. The position of the actuator 606 (e.g., the degree of extension or retraction of the actuator, etc.) may be provided as position feedback 618. In some embodiments, the position feedback 618 is provided to the driver circuit 604 to update the control signal to the actuator 606. In some embodiments, a plunger assembly 608 is coupled to the actuator 606. The plunger assembly 608 may be coupled to the actuator 606 by a coupling body (e.g., coupling body 308 of FIGS. 3A-3D). The plunger assembly 608 may be actuated responsive to extension or retraction of the actuator 606. In some embodiments, force sensor 610A measures the amount of force a plunger tip 612 exerts on a substrate 614. The plunger tip 612 may be coupled to the plunger assembly 608. The measured force (e.g., by the force sensor 610A) is provided as force feedback 616A. In some embodiments, the force feedback 616 is provided to the driver circuit 604 to update the control signal to the actuator 606. In some embodiments, the driver circuit 604 updates the control signal so that less than a threshold amount of force is exerted by the plunger tip 612 on the substrate 614. In some embodiments, the threshold amount of force is tunable (e.g., by a user, an engineer, a technician, etc.).

Referring to FIG. 6B, a control algorithm 600B for controlling a substrate gripping assembly such as substrate gripping assembly 400 of FIGS. 4A-4D is shown, according to some embodiments. Elements illustrated in FIG. 6B having same or similar reference numbers to those in FIG. 6A may have similar or same structure and/or functionality. In some embodiments, as plunger assembly 608 is actuated (e.g., responsive to extension or retraction of actuator 606), a strain gauge 610B detects strain in the plunger assembly. In some embodiments, strain gauge 610B detects strain in a flexure joint of plunger assembly 608 (e.g., flexure joint 430 of FIGS. 4A-4D). In some embodiments, the strain data (e.g., from strain gauge 610B) is provided as strain feedback 616B to the driver circuit 604 and/or to the actuator 606. The strain feedback 616B may be indicative of the amount of force applied by the plunger tip 612 on the substrate 614. In some embodiments, driver circuit 604 updates the control signal to the actuator 606 based on the strain feedback 616B so that less than a threshold amount of force is applied by the plunger tip 612 on the substrate 614. In some embodiments, the actuator 606 uses the strain feedback 616B to update actuation of the plunger assembly 608.

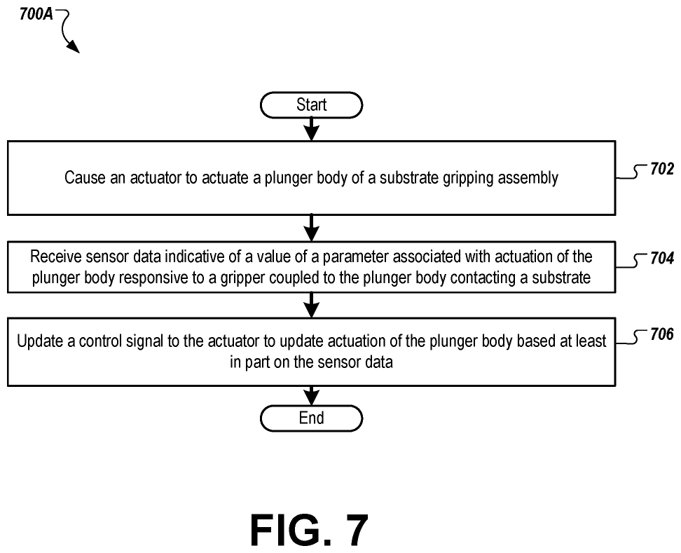

FIG. 7 is a flow chart of a method 700 of controlling a substrate gripping assembly, according to some embodiments. In some embodiments, method 700 is performed by a control system that can include hardware (circuitry, dedicated logic, etc.), software (such as is run on a general purpose computer system or a dedicated machine), firmware, or some combination thereof.

For simplicity of explanation, method 700 is depicted and described as a series of operations. However, operations in accordance with this disclosure can occur in various orders and/or concurrently and with other operations not presented and described herein. Furthermore, not all illustrated operations may be performed to implement method 700 in accordance with the disclosed subject matter. In addition, those skilled in the art will understand and appreciate that method 700 could alternatively be represented as a series of interrelated states via a state diagram or events.

At block 702, processing logic causes an actuator to actuate a plunger body of a substrate gripping assembly. In some embodiments, a control signal is sent to an actuator (e.g., actuators 302, 402, 502, etc.) to extend or retract the actuator to cause the plunger body to extend or retract. The plunger body may include a gripper (e.g., grippers 320, 420, 520, etc.) on a distal end that is configured to contact a substrate responsive to actuation of the plunger body.

At block 704, processing logic receives sensor data indicative of a value of a parameter associated with actuation of the plunger body responsive to the gripper coupled to the plunger body contacting a substrate. In some embodiments, the value of the parameter is indicative of the force applied by the gripper on the substrate. In some embodiments, the sensor data is force data (e.g., from a force sensor). In some embodiments, the sensor data is strain data (e.g., from a strain gauge).

At block 706, processing logic updates a control signal to the actuator to update actuation of the plunger body based at least in part on the sensor data. In some embodiments, processing logic determines the amount of force applied by the gripper on the substrate based on the sensor data (e.g., received at block 704). The processing logic may update the control signal to the actuator so that the gripper is caused to exert less than a threshold amount of force on the substrate. In some embodiments, the updated control signal causes the actuator to stop extending and/or causes the actuator to retract.

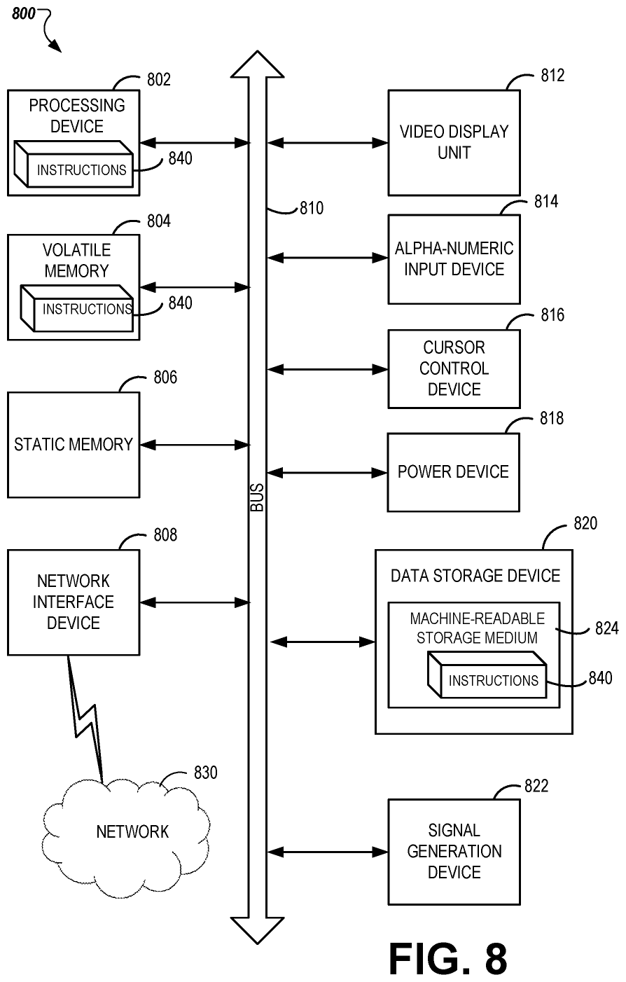

FIG. 8 is a block diagram illustrating a computer system 800 for use in accordance with the embodiments of the present disclosure. In alternative implementations, the machine may be connected (e.g., networked) to other machines in a LAN, a WAN, an intranet, an extranet, or the Internet. The machine may operate in the capacity of a server or a client machine in client-server network environment, or as a peer machine in a peer-to-peer (or distributed) network environment. The machine may be a personal computer (PC), a tablet PC, a PDA, a cellular telephone, a web appliance, a server, a network router, switch or bridge, or any machine capable of executing a set of instructions (sequentially or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein. Some or all of the components of the computer system 800 may be utilized by or illustrative of any of the electronic components described herein.

The exemplary computer system 800 includes a processing device (processor) 802, a main memory 804 (e.g., ROM, flash memory, dynamic random access memory (DRAM) such as synchronous DRAM (SDRAM) or Rambus DRAM (RDRAM), etc.), a static memory 806 (e.g., flash memory, static random access memory (SRAM), etc.), and a data storage device 820, which communicate with each other via a bus 810.

Processor 802 represents one or more general-purpose processing devices such as a microprocessor, central processing unit, or the like. More particularly, the processor 802 may be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processor 802 may also be one or more special-purpose processing devices such as an application specific integrated circuit (ASIC), a field programmable gate array (FPGA), a digital signal processor (DSP), network processor, or the like. The processor 802 is configured to execute instructions 840 for performing the operations discussed herein.

The computer system 800 may further include a network interface device 808. The computer system 800 also may include a video display unit 812 (e.g., a liquid crystal display (LCD), a cathode ray tube (CRT), or a touch screen), an alphanumeric input device 814 (e.g., a keyboard), a cursor control device 816 (e.g., a mouse), and a signal generation device 822 (e.g., a speaker).

Power device 818 may monitor a power level of a battery used to power the computer system 800 or one or more of its components. The power device 818 may provide one or more interfaces to provide an indication of a power level, a time window remaining prior to shutdown of computer system 800 or one or more of its components, a power consumption rate, an indicator of whether computer system is utilizing an external power source or battery power, and other power related information. In some implementations, indications related to the power device 818 may be accessible remotely (e.g., accessible to a remote back-up management module via a network connection). In some implementations, a battery utilized by the power device 818 may be an uninterruptable power supply (UPS) local to or remote from computer system 800. In such implementations, the power device 818 may provide information about a power level of the UPS.

The data storage device 820 may include a computer-readable storage medium 824 (e.g., a non-transitory computer-readable storage medium) on which is stored one or more sets of instructions 840 (e.g., software) embodying any one or more of the methodologies or functions described herein. These instructions 840 may also reside, completely or at least partially, within the main memory 804 and/or within the processor 802 during execution thereof by the computer system 800, the main memory 804, and the processor 802 also constituting computer-readable storage media. The instructions 840 may further be transmitted or received over a network 830 via the network interface device 808. While the computer-readable storage medium 824 is shown in an exemplary implementation to be a single medium, it is to be understood that the computer-readable storage medium 824 may include a single medium or multiple media (e.g., a centralized or distributed database, and/or associated caches and servers) that store the one or more sets of instructions 840.

The preceding description sets forth numerous specific details such as examples of specific systems, components, methods, and so forth in order to provide a good understanding of several embodiments of the present disclosure. It will be apparent to one skilled in the art, however, that at least some embodiments of the present disclosure can be practiced without these specific details. In other instances, well-known components or methods are not described in detail or are presented in simple block diagram format in order to avoid unnecessarily obscuring the present disclosure. Thus, the specific details set forth are merely exemplary. Particular implementations can vary from these exemplary details and still be contemplated to be within the scope of the present disclosure.

Reference throughout this specification to “one embodiment” or “an embodiment” means that a particular feature, structure, or characteristic described in connection with the embodiment is included in at least one embodiment. Thus, the appearances of the phrase “in one embodiment” or “in an embodiment” in various places throughout this specification are not necessarily all referring to the same embodiment. In addition, the term “or” is intended to mean an inclusive “or” rather than an exclusive “or.” When the term “about” or “approximately” is used herein, this is intended to mean that the nominal value presented is precise within ±10%.

Although the operations of the methods herein are shown and described in a particular order, the order of operations of each method can be altered so that certain operations can be performed in an inverse order so that certain operations can be performed, at least in part, concurrently with other operations. In another embodiment, instructions or sub-operations of distinct operations can be in an intermittent and/or alternating manner.

It is understood that the above description is intended to be illustrative, and not restrictive. Many other embodiments will be apparent to those of skill in the art upon reading and understanding the above description. The scope of the disclosure should, therefore, be determined with reference to the appended claims, along with the full scope of equivalents to which such claims are entitled.

What is claimed is:

1. A substrate gripping system, comprising:
a plunger body actuatable by an actuator;
a gripper at a distal end of the plunger body, wherein the gripper is configured to grip a substrate responsive to actuation of the plunger body by the actuator;
a sensor configured to measure a value of a parameter associated with actuation of the plunger body; and
a controller configured to cause the actuator to actuate the plunger body based at least partially on the value of the parameter measured by the sensor.

2. The substrate gripping system of claim 1, wherein the value of the parameter associated with actuation of the plunger body is indicative of force applied by the gripper on a gripped substrate.

3. The substrate gripping system of claim 1, wherein the plunger body is coupled to the actuator by a coupling body, and wherein the coupling body is guided by a linear motion guide during motion caused by the actuator.

4. The substrate gripping system of claim 3, wherein the coupling body is configured to move relative to the plunger body upon contact of the gripper with the substrate.

5. The substrate gripping system of claim 1, further comprising:
a damper configured to reduce an impulse between the gripper and the substrate upon contact of the gripper and the substrate responsive to actuation of the plunger body.

6. The substrate gripping system of claim 5, wherein the damper comprises an electromagnet configured to interact with the plunger body via an electromagnetic force generated by the electromagnet responsive to the gripper contacting the substrate.

7. The substrate gripping system of claim 1, wherein the sensor comprises one or more of a strain gauge or a force sensor.

8. The substrate gripping system of claim 1, wherein the plunger body comprises a flexure joint between the actuator and the gripper, and wherein the flexure joint is configured to compress responsive to the plunger body actuating to cause the gripper to grip the substrate.

9. The substrate gripping system of claim 1, wherein the controller is configured to control the actuator such that the gripper exerts less than a threshold amount of force on the substrate.

10. The substrate gripping system of claim 1, further comprising:
a bearing to couple the gripper to the plunger body, wherein the bearing is configured to allow the gripper to rotate with respect to the plunger body within a threshold range of rotation.

11. The substrate gripping system of claim 1, wherein the actuator is selected from a group consisting of a servo actuator, a stepper actuator, a stacked-solenoid actuator, a rack-and-pinion-based actuator, and a piezoelectric-based actuator.

12. The substrate gripping system of claim 1, wherein the controller is configured to detect presence of the substrate based on data from the sensor.

13. A system, comprising:
a substrate gripping assembly comprising:
a plunger body;
an actuator configured to actuate the plunger body;
a gripper coupled to the plunger body and configured to grip a substrate; and
a controller to control the substrate gripping assembly, wherein the controller is configured to:
cause the actuator to actuate the plunger body, wherein the gripper is caused to contact the substrate responsive to actuation of the plunger body;
receive sensor data indicative of a value of a parameter associated with actuation of the plunger body; and
update a control signal to the actuator to update actuation of the plunger body based at least in part on the sensor data.

14. The system of claim 13, wherein the value of the parameter associated with actuation of the plunger body is indicative of force applied by the gripper on the substrate.

15. The system of claim 13, wherein the substrate gripping assembly further comprises:
a damper configured to reduce an impulse between the gripper and the substrate upon contact of the gripper and the substrate responsive to actuation of the plunger body.

16. The system of claim 13, wherein updating actuation of the plunger body comprises causing the gripper to exert less than a threshold amount of force on the substrate.

17. The system of claim 13, wherein the controller is further configured to:
detect presence of the substrate based on the sensor data.

18. A method comprising:
causing an actuator to actuate a plunger body of a substrate gripping assembly;
receiving sensor data indicative of a value of a parameter associated with actuation of the plunger body responsive to a gripper coupled to the plunger body contacting a substrate; and
updating a control signal to the actuator to update actuation of the plunger body based at least in part on the sensor data.

19. The method of claim 18, wherein the value of the parameter associated with actuation of the plunger body is indicative of force applied by the gripper on the substrate.

20. The method of claim 18, wherein updating actuation of the plunger body comprises causing the gripper to exert less than a threshold amount of force on the substrate.
